(19) United States
(12) Patent Application Publication
(10) Pub. No.: US 2024/0268484 A1
(43) Pub. Date: Aug. 15, 2024

(54) AEROSOL PROVISION SYSTEMS

(71) Applicant: NICOVENTURES TRADING LIMITED, London (GB)

(72) Inventor: Patrick Moloney, London (GB)

(21) Appl. No.: 18/568,636

(22) PCT Filed: Jun. 21, 2022
(86) PCT No.: PCT/GB2022/051576

§ 371 Date: Dec. 8, 2023

(30) Foreign Application Priority Data
Jun. 21, 2021 (GB) 2108884.4

(51) Int. Cl. A24F 40/65; A24F 40/53; H04L 67/141

(52) U.S. Cl. CPC A24F 40/65; A24F 40/53; H04L 67/141

(57) ABSTRACT

The present invention relates to circuitry for an aerosol delivery system, the circuitry being configured to monitor usage of a first device in the aerosol delivery system; determine that there is data available for transfer between the first device and a second device of the aerosol delivery system, based on monitoring the usage of the first device; and initiate a procedure for transfer of data between the first and second devices over a data communication interface, based on determining there is data available for transfer between the first and second devices.

### FIELD

The present disclosure relates to aerosol delivery systems, as well as to circuitry and device comprising such circuitry for use in the aerosol delivery systems.

### BACKGROUND

Aerosol delivery devices such as electronic cigarettes (e-cigarettes) generally contain a aerosol generating material, such as a reservoir of a source liquid, which may contain an active substance and/or a flavour, from which an aerosol or vapour is generated for inhalation by a user, for example through heat vaporisation. Thus, an aerosol provision device will typically comprise a aerosol generation chamber containing an aerosol generator, e.g. a heating element, arranged to vaporise or aerosolise a portion of precursor material to generate a vapour or aerosol in the aerosol generation chamber. As a user inhales on the device and electrical power is supplied to the vaporiser, air is drawn into the device through an inlet hole and along an inlet air channel connecting to the aerosol generation chamber where the air mixes with vaporised precursor material to form a condensation aerosol. There is an outlet air channel connecting from the aerosol generation chamber to an outlet in the mouthpiece and the air drawn into the aerosol generation chamber as a user inhales on the mouthpiece continues along the outlet flow path to the mouthpiece outlet, carrying the aerosol with it, for inhalation by the user. Some electronic cigarettes may also include a flavour element in the air flow path through the device to impart additional flavours. Such devices may sometimes be referred to as hybrid devices, and the flavour element may, for example, include a portion of tobacco arranged in the air flow path between the aerosol generation chamber and the mouthpiece such that aerosol/condensation aerosol drawn through the device passes through the portion of tobacco before exiting the mouthpiece for user inhalation.

Some aerosol delivery devices are configured to connect via a wired or wireless connection to one or more further devices of a wider delivery system, to exchange data with said devices. For instance, an aerosol delivery device may be able to establish a wireless data connection with a smartphone in order to enable usage data acquired by the aerosol delivery device to be uploaded to an application (‘app’) on the smartphone, or to receive control parameters or software updates from the smartphone. More broadly, an aerosol delivery device may be configured to connect to other devices such as cases, recharge/refill docks, vending machines, wearables and networked servers, either directly, or indirectly via relaying of data via intermediate data connections with other devices. To transfer data between first and second devices of a delivery system, a user may generally be required to initiate a wireless or wired connection between the devices. It may be considered advantageous to ensure data connections are established in appropriate contexts to allow timely exchange of available data within a delivery system.

Various approaches are described herein which seek to help address or mitigate at least some of the issues discussed above.

### SUMMARY

In one aspect, there is provided circuitry for an aerosol delivery system, the circuitry being configured to:
monitor usage of a first device in the aerosol delivery system;
determine that there is data available for transfer between the first device and a second device of the aerosol delivery system, based on monitoring the usage of the first device; and
initiate a procedure for transfer of data between the first and second devices over a data communication interface, based on determining there is data available for transfer between the first and second devices.

In one embodiment, determining there is data available to be transferred comprises determining an amount of data stored on the first device has reached a predetermined threshold.

In one embodiment, the data available to be transferred comprises usage data collected by the first device.

In one embodiment, the data available to be transferred comprises data to be transferred from the second device to the first device in order to modify the operation of the first device.

In one embodiment, determining that there is data available to be transferred from the second device to the first device comprises determining a certain time has elapsed since data for modifying the operation of the first device was last received by the first device.

In one embodiment, the data comprises a software update or a control parameter for modifying the operation of the first device or second device.

In one embodiment, monitoring the usage of the first device comprises monitoring how often a data connection is established between the first device and the second device.

In one embodiment, determining there is data available to be transferred between the first and second devices comprises determining that a certain time has elapsed since a data connection was last established between the first device and the second device.

In one embodiment, the elapsed time after which it is determined data is available to be transferred is determined based on information about the user of the first device.

In one embodiment, the information about the user comprises at least one of the following:
i) information derived from the activity of the user on an online application
ii) information about the location and/or movement of the user
iii) information provided by the user via a form or questionnaire
iv) information derived from sensing one or more physical characteristics of the user.

In one embodiment, determining there is data available to be transferred between the first and second devices comprises determining that a user profile associated with the user has changed, wherein the user profile is established based on the information about a user of the first device.

In one embodiment, monitoring the usage of the first device comprises monitoring the geographical location of the first device and/or the second device.

In one embodiment, a procedure for the establishment of a data connection between the first and second devices is initiated based on determining the first device entered a predefined geographical location.

In one embodiment, a procedure for the establishment of a data connection between the first and second devices is initiated based on determining the second device entered a predefined geographical location.

In one embodiment, the circuitry is comprised in the second device, and determining there is data available to be transferred comprises receiving an indication from the first device over a wireless interface.

In one embodiment, the indication comprises a message received from the first device, and wherein determining whether there is data available to be transferred between the first and second devices of the aerosol delivery system comprises determining the message received from the first device meets a predefined criterion.

In one embodiment, the message comprises a beacon signal or a paging message.

In one embodiment, the first device comprises an aerosol delivery device, and the second device comprises a personal computing device or a server.

In one embodiment, the first device comprises a personal computing device configured to collect usage data from an aerosol delivery device, and the second device comprises a personal computing device or a server.

In one embodiment, the circuitry is comprised in the first device.

In one embodiment, the circuitry is comprised in the second device.

In one embodiment, initiating the procedure for transfer of data between the first and second devices comprises providing an indication via the first device that a user should establish a data connection for the transfer of data between the first and second devices.

In one embodiment, initiating the procedure for transfer of data between the first and second devices comprises providing an indication via the second device that a user should establish a data connection for the transfer of data between the first and second devices.

In one embodiment, initiating the procedure for transfer of data between the first and second devices comprises providing an indication via a further device of the aerosol delivery system that a user should establish a data connection for the transfer of data between the first and second devices.

In one embodiment, the indication that a user should establish a data connection for the transfer of data between the first and second devices comprises an audible or a visual signal.

In one embodiment, initiating the procedure for transfer of data between the first and second devices comprises causing a first one of the first and second devices to establish a data connection with a second one of the first and second devices.

In one embodiment, the circuitry is configured to cause the first one of the first and second devices to establish the data connection with the second one of the first and second devices without requiring any input from a user to initiate the data connection.

In one embodiment, the circuitry is further configured to cause first and second devices to transfer the data available for transfer between the first and second devices over the data connection.

In a further aspect, there is provided a method of operating circuitry for an aerosol delivery system, the method comprising the steps of:
causing the circuitry to monitor usage of a first device in the aerosol delivery system;
determining that there is data available for transfer between the first device and a second device of the aerosol delivery system, based on monitoring the usage of the first device; and
initiating a procedure for transfer of data between the first and second devices over a data communication interface, based on determining there is data available for transfer between the first and second devices.

In a further aspect, there is provided an aerosol delivery system comprising at least a first and second device, wherein the aerosol delivery system comprises circuitry configured to:
monitor usage of the first device;
wherein the circuitry is configured to determine that there is data available for transfer between the first device and a second device, based on monitoring the usage of the first device; and
initiate a procedure for transfer of data between the first and second devices over a data communication interface, based on determining there is data available for transfer between the first and second devices.

In a further aspect, there is provided an aerosol delivery device for use in an aerosol delivery system comprising a second device, the aerosol delivery device comprising circuitry configured to:
monitor usage of a first one of the aerosol delivery device and the second device;
wherein the circuitry is configured to determine that there is data available for transfer between the first and second devices, based on monitoring the usage of the first one of the first device and second devices; and
initiate a procedure for transfer of data between the first and second devices over a data communication interface, based on determining there is data available for transfer between the first and second devices.

In a further aspect, there is provided a non-transitory tangible computer readable medium having stored thereon software instructions that, when executed by circuitry comprised in a device of an aerosol delivery system, cause the circuitry to:
monitor usage of a first device of the aerosol delivery system;
determine that there is data available for transfer between the first device and a second device of the aerosol delivery system, based on monitoring the usage of the first one of the first device and second devices; and
initiate a procedure for transfer of data between the first and second devices over a data communication interface, based on determining there is data available for transfer between the first and second devices.

### BRIEF DESCRIPTION OF THE DRAWINGS

Embodiments of the disclosure will now be described, by way of example only, with reference to the accompanying drawings, in which:

FIG. 1 is a schematic diagram of an aerosol delivery device in accordance with some embodiments of the disclosure.

FIG. 2 is a schematic diagram of a delivery system for use with an aerosol delivery device in accordance with some embodiments of the disclosure.

FIG. 3 is a flow diagram detailing steps performed by circuitry of a delivery system in accordance with some embodiments of the disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to delivery system 1 comprising aerosol delivery device 10 (which may also be referred to as vapour delivery devices) such as nebulisers or e-cigarettes or tobacco heating products which generate aerosols by heating but not burning tobacco. Throughout the following description the term “e-cigarette” or “electronic cigarette” may sometimes be used, but it will be appreciated this term may be used interchangeably with aerosol delivery system 1/device and electronic aerosol delivery system 1/device. Furthermore, and as is common in the technical field, the terms “aerosol” and “vapour”, and related terms such as “vaporise”, “volatilise” and “aerosolise”, may generally be used interchangeably. In some embodiments, a delivery system 1 is a tobacco heating system, also known as a heat-not-burn system. In some embodiments, the delivery system 1 is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aero aerosol generating material. The solid aerosol generating material may comprise, for example, tobacco or a non-tobacco product. Meanwhile in some embodiments, the non-combustible aerosol provision system generates a vapour/aerosol from one or more such aerosolisable materials.

Aerosol delivery device 10s (e-cigarettes) often, though not always, comprise a modular assembly including both a reusable part and a replaceable (disposable) cartridge part. Often the replaceable cartridge part will comprise the aerosol generating material and the vaporiser and the reusable part will comprise the power supply (e.g. rechargeable power source) and control circuitry. It will be appreciated these different parts may comprise further elements depending on functionality. For example, the reusable device part will often comprise a user interface for receiving user input and displaying operating status characteristics, and the replaceable cartridge part in some cases comprises a temperature sensor for helping to control temperature. Cartridges are electrically and mechanically coupled to a control unit for use, for example using a screw thread, bayonet, or magnetic coupling with appropriately arranged electrical contacts. When the aerosol generating material in a cartridge is exhausted, or the user wishes to switch to a different cartridge having a different aerosol generating material, a cartridge may be removed from the control unit and a replacement cartridge attached in its place. Devices conforming to this type of two-part modular configuration may generally be referred to as two-part devices.

It is common for electronic cigarettes to have a generally elongate shape. For the sake of providing a concrete example, certain embodiments of the disclosure described herein will be taken to comprise this kind of generally elongate two-part device employing disposable cartridges. However, it will be appreciated the underlying principles described herein may equally be adopted for different aerosol delivery device 10 configurations, for example single-part devices or modular devices comprising more than two parts, refillable devices and single-use disposable devices, as well as devices conforming to other overall shapes, for example based on so-called box-mod high performance devices that typically have a more boxy shape. More generally, it will be appreciated certain embodiments of the disclosure are based on aerosol delivery device 10/systems which are operationally configured to provide functionality in accordance with the principles described herein and the constructional aspects of the aerosol delivery device 10 configured to provide the functionality in accordance with certain embodiments of the disclosure is not of primary significance.

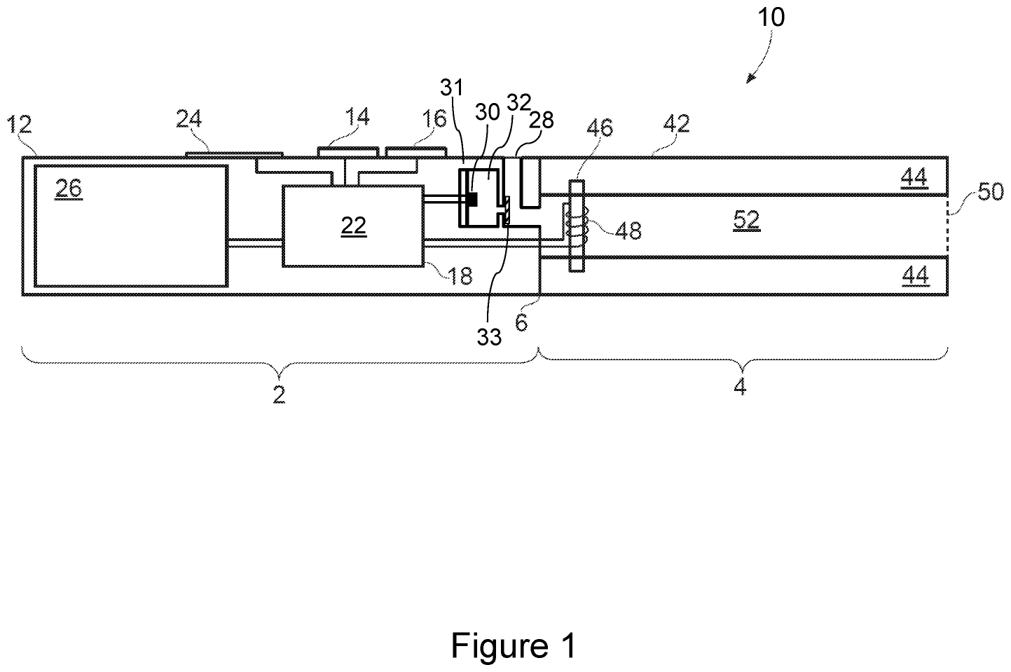

FIG. 1 is a cross-sectional view through an example delivery device 10 in accordance with certain embodiments of the disclosure. The delivery device 10 comprises two main components, namely a reusable part 2 and a replaceable/disposable cartridge part 4. In normal use the reusable part 2 and the cartridge part 4 are releasably coupled together at an interface 6. When the cartridge part is exhausted or the user simply wishes to switch to a different cartridge part, the cartridge part may be removed from the reusable part and a replacement cartridge part attached to the reusable part in its place. The interface 6 provides a structural, electrical and airflow path connection between the two parts and may be established in accordance with conventional techniques, for example based around a screw thread, magnetic or bayonet fixing with appropriately arranged electrical contacts and openings for establishing the electrical connection and airflow path between the two parts as appropriate. The specific manner by which the cartridge part 4 mechanically mounts to the reusable part 2 is not significant to the principles described herein, but for the sake of a concrete example is assumed here to comprise a magnetic coupling (not represented in FIG. 1). It will also be appreciated the interface 6 in some implementations may not support an electrical and/or airflow path connection between the respective parts. For example, in some implementations an aerosol generator may be provided in the reusable part 2 rather than in the cartridge part 4, or the transfer of electrical power from the reusable part 2 to the cartridge part 4 may be wireless (e.g. based on electromagnetic induction), so that an electrical connection between the reusable part and the cartridge part is not needed. Furthermore, in some implementations the airflow through the electronic cigarette might not go through the reusable part so that an airflow path connection between the reusable part and the cartridge part is not needed. In some instances, a portion of the airflow path may be defined at the interface between portions of reusable part 2 and cartridge part 4 when these are coupled together for use.

The cartridge part 4 may in accordance with certain embodiments of the disclosure be broadly conventional. In FIG. 1, the cartridge part 4 comprises a cartridge housing 42 formed of a plastics material. The cartridge housing 42 supports other components of the cartridge part and provides the mechanical interface 6 with the reusable part 2. The cartridge housing is generally circularly symmetric about a longitudinal axis along which the cartridge part couples to the reusable part 2. In this example the cartridge part has a length of around 4 cm and a diameter of around 1.5 cm. However, it will be appreciated the specific geometry, and more generally the overall shapes and materials used, may be different in different implementations.

Within the cartridge housing 42 may be a reservoir 44 that contains aerosol generating material. Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise plant material such as tobacco. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid. The aerosol-generating material may comprise one or more active substances and/or flavours, one or more aerosol-former materials, and optionally one or more other functional material. The aerosol-former material may comprise one or more constituents capable of forming an aerosol. In some embodiments, the aerosol-former material may comprise one or more of glycerine, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The one or more other functional materials may comprise one or more of pH regulators, colouring agents, preservatives, binders, fillers, stabilizers, and/or antioxidants. The aerosol-generating material may be present on or in a support, to form a substrate. The support may, for example, be or comprise paper, card, paperboard, cardboard, reconstituted material, a plastics material, a ceramic material, a composite material, glass, a metal, or a metal alloy.

In the example shown schematically in FIG. 1, a reservoir 44 is provided configured to store a supply of liquid aerosol generating material. In this example, the liquid reservoir 44 has an annular shape with an outer wall defined by the cartridge housing 42 and an inner wall that defines an airflow path 52 through the cartridge part 4. The reservoir 44 is closed at each end with end walls to contain the aerosol generating material. The reservoir 44 may be formed in accordance with conventional techniques, for example it may comprise a plastics material and be integrally moulded with the cartridge housing 42.

The cartridge part may further comprise an aerosol generator 48 located towards an end of the reservoir 44 opposite to the mouthpiece outlet 50. An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

It will be appreciated that in a two-part device such as shown in FIG. 1, the aerosol generator may be in either of the reusable part 2 or the cartridge part 4. For example, in some embodiments, the aerosol generator 48 (e.g. a heater) may be comprised in the reusable part 2, and is brought into proximity with a portion of aerosol generating material in the cartridge 4 when the cartridge is engaged with the reusable part 2. In such embodiments, the cartridge may comprise a portion of aerosol generating material, and an aerosol generator 48 comprising a heater is at least partially inserted into or at least partially surrounds the portion of aerosol generating material as the cartridge 4 is engaged with the reusable part 2.

In the example of FIG. 1, a wick 46 in contact with a heater 48 extends transversely across the cartridge airflow path 52 with its ends extending into the reservoir 44 of a liquid aerosol generating material through openings in the inner wall of the reservoir 44. The openings in the inner wall of the reservoir are sized to broadly match the dimensions of the wick 46 to provide a reasonable seal against leakage from the liquid reservoir into the cartridge airflow path without unduly compressing the wick, which may be detrimental to its fluid transfer performance.

The wick 46 and heater 48 are arranged in the cartridge airflow path 52 such that a region of the cartridge airflow path 52 around the wick 46 and heater 48 in effect defines a vaporisation region for the cartridge part 4. Aerosol generating material in the reservoir 44 infiltrates the wick 46 through the ends of the wick extending into the reservoir 44 and is drawn along the wick by surface tension/capillary action (i.e. wicking). The heater 48 in this example comprises an electrically resistive wire coiled around the wick 46. In the example of FIG. 1, the heater 48 comprises a nickel chrome alloy (Cr20Ni80) wire and the wick 46 comprises a glass fibre bundle, but it will be appreciated the specific aerosol generator configuration is not significant to the principles described herein. In use electrical power may be supplied to the heater 48 to vaporise an amount of aerosol generating material (aerosol generating material) drawn to the vicinity of the heater 48 by the wick 46. Vaporised aerosol generating material may then become entrained in air drawn along the cartridge airflow path from the vaporisation region towards the mouthpiece outlet 50 for user inhalation.

As noted above, the rate at which aerosol generating material is vaporised by the vaporiser (heater) 48 will depend on the amount (level) of power supplied to the heater 48. Thus electrical power can be applied to the heater to selectively generate aerosol from the aerosol generating material in the cartridge part 4, and furthermore, the rate of aerosol generation can be changed by changing the amount of power supplied to the heater 48, for example through pulse width and/or frequency modulation techniques.

The reusable part 2 comprises an outer housing 12 having with an opening that defines an air inlet 28 for the e-cigarette, a power source 26 (for example a battery) for providing operating power for the electronic cigarette, control circuitry 18 for controlling and monitoring the operation of the electronic cigarette, a first user input button 14, a second user input button 16, and a visual display 24.

The outer housing 12 may be formed, for example, from a plastics or metallic material and in this example has a circular cross section generally conforming to the shape and size of the cartridge part 4 so as to provide a smooth transition between the two parts at the interface 6. In this example the reusable part has a length of around 8 cm so the overall length of the e-cigarette when the cartridge part and reusable part are coupled together is around 12 cm. However, and as already noted, it will be appreciated that the overall shape and scale of an electronic cigarette implementing an embodiment of the disclosure is not significant to the principles described herein.

The air inlet 28 connects to an airflow path 51 through the reusable part 2. The reusable part airflow path 51 in turn connects to the cartridge airflow path 52 across the interface 6 when the reusable part 2 and cartridge part 4 are connected together. Thus, when a user inhales on the mouthpiece opening 50, air is drawn in through the air inlet 28, along the reusable part airflow path 51, across the interface 6, through the aerosol generation region in the vicinity of the aerosol generator 48 (where vaporised aerosol generating material becomes entrained in the air flow), along the cartridge airflow path 52, and out through the mouthpiece opening 50 for user inhalation.

The power source 26 in this example is rechargeable and may be of a conventional type, for example of the kind normally used in electronic cigarettes and other applications requiring provision of relatively high currents over relatively short periods. The power source 26 may be recharged through a charging connector in the reusable part housing 12, for example a USB connector.

First and second user input buttons 14, 16 may be provided, which in this example are conventional mechanical buttons, for example comprising a spring mounted component which may be pressed by a user to establish an electrical contact. In this regard, the input buttons may be considered input devices for detecting user input and the specific manner in which the buttons are implemented is not significant. The buttons may be assigned to functions such as switching the delivery device 10 on and off, initiating communication links with other electronic devices according to approaches set out further herein, and adjusting user settings such as a power to be supplied from the power source 26 to an aerosol generator 48. However, the inclusion of user input buttons is optional, and in some embodiments buttons may not be included.

A display 24 may be provided to give a user with a visual indication of various characteristics associated with the aerosol delivery device 10, for example current power setting information, remaining power source power, and so forth. The display may be implemented in various ways. In this example the display 24 comprises a conventional pixilated LCD screen that may be driven to display the desired information in accordance with conventional techniques. In other implementations the display may comprise one or more discrete indicators, for example LEDs, that are arranged to display the desired information, for example through particular colours and/or flash sequences. More generally, the manner in which the display is provided and information is displayed to a user using the display is not significant to the principles described herein. For example some embodiment may not include a visual display and may include other means for providing a user with information relating to operating characteristics of the aerosol delivery device 10/system, for example using audio signalling, or may not include any means for providing a user with information relating to operating characteristics of the aerosol delivery device 10/system.

A controller 22 is suitably configured/programmed to control the operation of the aerosol delivery device 10 to provide functionality in accordance with embodiments of the disclosure as described further herein, as well as for providing conventional operating functions of the aerosol delivery device 10 in line with the established techniques for controlling such devices. The controller (processor circuitry) 22 may be considered to logically comprise various sub-units/circuitry elements associated with different aspects of the operation of the delivery device 10. In this example the controller 22 comprises power supply control circuitry for controlling the supply of power from the power source 26 to the aerosol generator 48 in response to user input, user programming circuitry 20 for establishing configuration settings (e.g. user-defined power settings) in response to user input, as well as other functional units/circuitry associated functionality in accordance with the principles described herein and conventional operating aspects of electronic cigarettes, such as display driving circuitry and user input detection circuitry. It will be appreciated the functionality of the controller 22 can be provided in various different ways, for example using one or more suitably programmed programmable computer(s) and/or one or more suitably configured application-specific integrated circuit(s)/circuitry/chip(s)/chipset(s) configured to provide the desired functionality.

As described further herein, the aerosol delivery device 10 comprises communication circuitry configured to enable a connection to be established with one or more further electronic devices to enable data transfer between the aerosol delivery device 10 and the further electronic device(s) in a delivery system 1. In some embodiments, the communication circuitry is integrated into controller 22, and in other embodiments it is implemented separately (comprising, for example, separate application-specific integrated circuit(s)/circuitry/chip(s)/chipset(s)). In some embodiments, the communication circuitry is configured to support communication between the aerosol delivery device 10 and one or more further electronic devices over a wireless interface. The communication circuitry may be configured to support wireless communications between the aerosol delivery device 10 and other electronic devices according to known data transfer protocols such as Bluetooth, ZigBee, WiFi, Wifi Direct, GSM, 2G, 3G, 4G, 5G, LTE, NFC, RFID. More generally, it will be appreciated that any wireless network protocol can in principle be used to support wireless communication between the aerosol delivery device 10 and further devices of the delivery system 1. In some embodiments, the communication circuitry is configured to support communication between the aerosol delivery device 10 and one or more further electronic devices over a wireless interface. This may be instead of or in addition to the configuration for wireless communications set out above. The communication circuitry may comprise any suitable interface for wired data connection, such as USB-C, micro-USB or Thunderbolt interfaces. More generally, it will be appreciated the communication circuitry may comprise any wired communication interface which enables the transfer of data, according to, for example, a packet data transfer protocol, and may comprise pin or contact pad arrangements configured to engage cooperating pins or contact pads on a dock, cable, or other external device which can be connected to the aerosol delivery device 10.

In some embodiments, reusable part 2 comprises an airflow sensor 30 which is electrically connected to the controller 22. In most embodiments, the airflow sensor 30 comprises a so-called “puff sensor”, in that the airflow sensor 30 is used to detect when a user is puffing on the device. In some embodiments, the airflow sensor comprises a switch in an electrical path providing electrical power from the power source 26 to the aerosol generator 48. In such embodiments, the airflow sensor 30 generally comprises a pressure sensor configured to close the switch when subjected to an particular range of pressures, enabling current to flow from the power source 26 to the aerosol generator 48 once the pressure in the vicinity of the airflow sensor 30 drops below a threshold value. The threshold value can be set to a value determined by experimentation to correspond to a characteristic value associated with the initiation of a user puff. In other embodiments, the airflow sensor 30 is connected to the controller 22, and the controller distributes electrical power from the power source 26 to the aerosol generator 48 in dependence of a signal received from the airflow sensor 30 by the controller 22. The specific manner in which the signal output from the airflow sensor 30 (which may comprise a measure of capacitance, resistance or other characteristic of the airflow sensor, made by the controller 22) is used by the controller 22 to control the supply of power from the power source 26 to the aerosol generator 48 can be carried out in accordance with any approach known to the skilled person.

The aerosol delivery device 10 may further comprise other sensors, configured with connections to controller 22, which may provide controller 22 with signals/data relating to, for example, the geographical position of the aerosol delivery device 10 (e.g. using a GPS receiver), an orientation of the aerosol delivery device 10 (e.g. using one or more tilt sensors and/or accelerometers), a temperature of the aerosol delivery device 10 (e.g. using a thermocouple), an ambient light intensity in the vicinity of the aerosol delivery device 10 (e.g. using a photodiode), or a quantity of aerosol generating material in the aerosol delivery device 10 (e.g. using optical or capacitive sensing). Such data comprises ‘usage data’ as discussed further herein, which may be collected on a continuous or periodic basis, being stored on a memory element (for example RAM, ROM or other memory format, including a cloud memory element, associated with controller 22) and/or transmitted continuously or periodically over a wired or wireless data interface as described further herein for storage at a further device (for example, a smartphone 100, a dock or case 200, a vending machine 300, a wearable 400 and/or a server 1000). The usage data obtained by one or more sensors may be stored or transmitted by the controller 22 in the ‘raw’ state (i.e. without analysis or conversion) or may be converted or analysed to generate further usage data for storage and/or transmission to further devices.

### Ecosystem

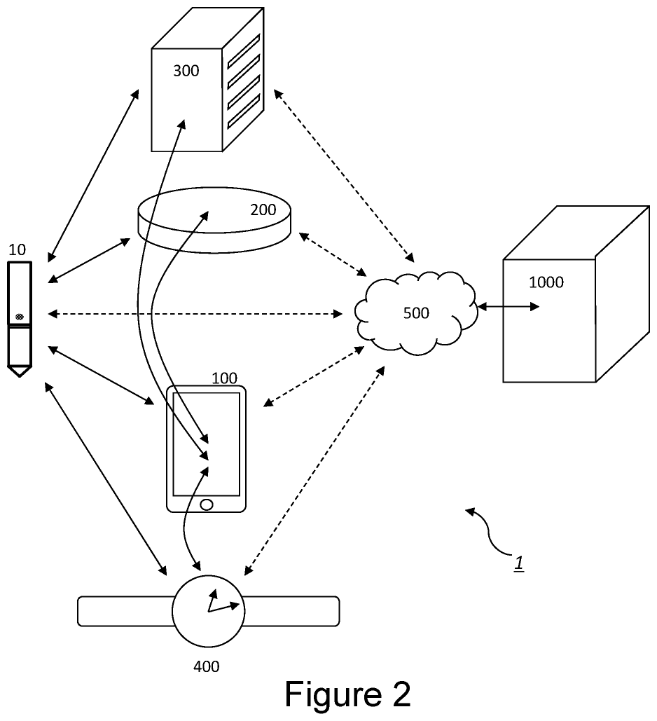

Referring now to FIG. 2, the aerosol delivery device 10 (or more generally any delivery device as described elsewhere herein) may operate within a wider delivery system 1/aerosol delivery system 1. Within the wider delivery system 1, a number of devices may communicate with each other, either directly (shown with solid arrows) or indirectly (shown with dashed arrows). This system can otherwise be referred to as a delivery ecosystem/aerosol delivery ecosystem.

An example aerosol delivery device 10 such as an e-cigarette may communicate directly with one or more other classes of device including but not limited to a smartphone 100, a dock 200 (e.g. a recharging case or home refill and/or charging station), a vending machine 300, or a wearable device 400 (e.g. a smart watch). In a similar manner, the aerosol delivery device 10 such as an e-cigarette may communicate directly with another device of the same class, i.e. an aerosol delivery device. As noted above, these devices may cooperate in any suitable configuration to form a delivery system 1. This communication may be supported by wired communication circuitry of the aerosol delivery device 10 (for example, using an interface such as USB-C, micro-USB, Thunderbolt, or another wired communication interface as described further herein), or by wireless communication circuitry of the aerosol delivery device 10 (for example, a Bluetooth, ZigBee, WiFi, Wifi Direct, GSM, 2G, 3G, 4G, 5G, LTE, NFC or RFID module, or another wireless communication interface as described further herein). The aerosol delivery device 10 may be configured to connect to different ones of other classes of device using different wired or wireless communication protocols, and a data connection between the aerosol delivery device 10 and any given second device may be established using wired and/or wireless communication. It will be appreciated that other classes of device comprised in delivery system 1 may comprise communication circuitry for wired or wireless data transmission similar to that set out further herein in relation to the aerosol delivery device 10. Accordingly, a smartphone 100, a dock 200 (e.g. a home refill and/or charging station), a vending machine 300, a wearable device 400 (e.g. a smart watch) or a server may be equipped with communication circuitry comprising a Bluetooth, ZigBee, WiFi, Wifi Direct, GSM, 2G, 3G, 4G, 5G, LTE, NFC, RFID or other wireless transmission module, and/or a wired interface such as USB-C, micro-USB, Thunderbolt or other wired interface. Communication circuitry of the aerosol delivery device 10 (implemented as a single module or separate modules) may enable it to communicate with different ones of the further classes of device using different wired and/or wireless data transmission protocols. According to one non-limiting example, an aerosol delivery device 10 may be configured with communication circuitry enabling it to communicate data wirelessly with a smartphone 100 and a wearable device 400 over a Bluetooth interface, and in a wired manner with a dock/case 200 over a USB-C interface.

The aerosol delivery device 10 and other classes of device in the delivery system 1 may communicate directly or indirectly with a server 1000 via a network such as the internet 500. The aerosol delivery device 10 may establish such communication directly, using one of the wireless communication protocols described further herein to communicate with communication node/transceiver infrastructure (such as a ‘base station’ or ‘evolved node-B’ in LTE terminology) which provides connectivity with the server 1000 (e.g. over a backhaul communication link). Alternatively or in addition, the aerosol delivery device 10 may establish communication with the server 1000 via another device in the delivery system 1, for example using a wired or wireless communication protocol to communicate with a smartphone 100, a dock/case 200, a vending machine 300, or a wearable device 400 which then communicates with the server 1000 (for example, via the internet 500) to either relay data to or from the aerosol delivery device 10, report upon its communications with the aerosol delivery device 10, or exchange information inferred about the aerosol delivery device 10 without a connection to the aerosol delivery device 10 being established. The smartphone 100, dock 200, or other device within the delivery ecosystem, such as a point of sale system/vending machine 300, may optionally act as a hub for one or more aerosol delivery device 10s 10 that only have short range transmission capabilities (provided, for example, by communication circuitry comprising a Bluetooth or RFID module). Such a hub may thus extend the battery life of an aerosol delivery device 10 whilst enabling data to be exchanged between the aerosol delivery device 10 and further devices of the aerosol delivery system 1 (for example, server 1000).

The other classes of device in the aerosol delivery system 1, such as the smartphone 100, dock 200, vending machine (or any other point of sale system) 300 and/or wearable 400 may also communicate indirectly with the server 1000 via a relay device, either to fulfil an aspect of their own functionality, or on behalf of the aerosol delivery system 10 (for example as a relay or co-processing unit). These devices may also transfer data with each other, either directly or indirectly via any of the wired or wireless communication protocols set out further herein.

### Data Connection Establishment

A given first and second device of the delivery system 1 may generally be in either a connected or unconnected state. The unconnected state may also be referred to as an idle state, and in such a state a given first device may not be detectable by other second devices (i.e. the first device is not transmitting any signalling enabling its existence and/or identity to be determined), or it may be available for establishing a connection with a second device (i.e. it may be advertising its existence/identity using beacon/advertisement signalling). In a connected state, the first and second devices are configured such that data may be transferred from the first to the second device (e.g. ‘uplink’ transmission) and/or transferred from the second to the first device (e.g. ‘downlink’ transmission). Accordingly, establishment of a connection between a first and second device may be considered to comprise the establishment of any state wherein the two devices can exchange data, regardless of the direction of data transfer. Non-limiting examples of connected states are the establishment of an RRC connected state according to the Long Term Evolution (LTE) standard, or a bonded/paired state according to the Bluetooth standard. When a first and second device of the delivery system 1 are configured to communicate wirelessly, a transition from an unconnected to a connected state will generally follow a procedure such as the following. In an initial enquiry step, a first device (for example, an aerosol delivery device 10) establishes the existence of a second device (for example, a smartphone 100) by receiving a beacon signal or other identifying signal/message from the second device. In an authentication step, the first and second devices exchange messaging to establish information relating to the data transfer protocol to be used for exchanging data (for example comprising coding and encryption parameters to be used when exchanging data packets). In a data transfer step, the first and second devices transfer data over an air interface established in accordance with an agreed data transfer protocol (for example, Bluetooth, ZigBee, RFID, or other protocols described further herein). This data transmission may be bi- or uni-directional. The data communication process for wired communications may be broadly similar with the difference that data is transmitted over a wired interface as opposed to a wireless interface. Further aspects of implementation for establishment of wireless and wired communications may be found in the standard documents for communication protocols such as those listed further herein.

It will be appreciated that any two devices of the delivery system 1 (for example an aerosol delivery device 10 and a smartphone 100) may transition from an unconnected state to a connected state to exchange data for a variety of reasons. In general, a transition to a connected state between a first and second device of the delivery system 1 will be initiated because circuitry of the delivery system 1 described further herein determines data is available for transfer between the first and second device. The identity of such data and the manner in which it is generated or becomes available is not of primary significance, and there are a wide range of ways in which data may be generated and become available for transfer at one or more devices of the delivery system 1.

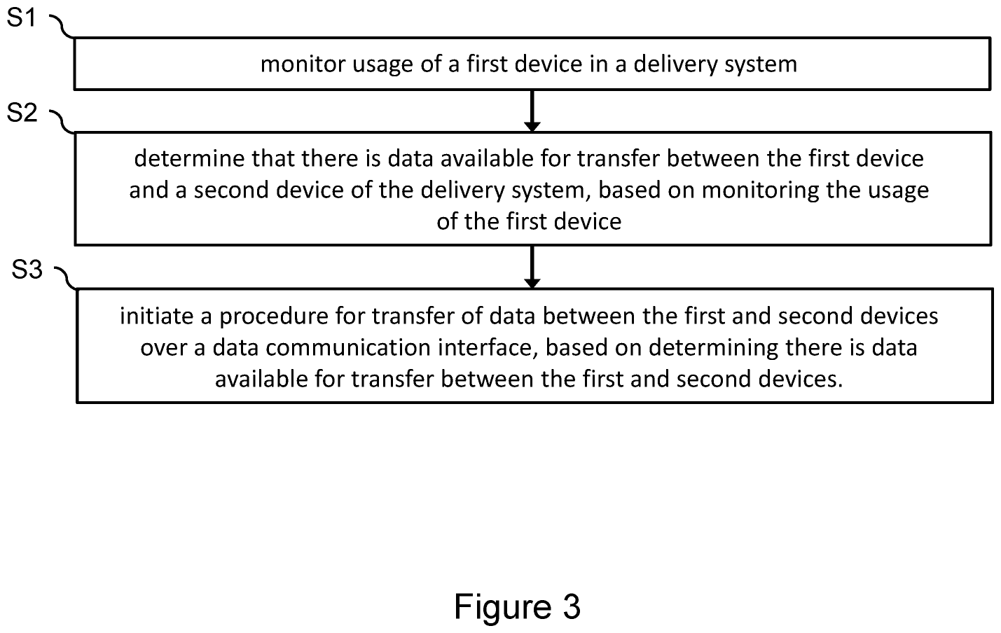

Turning to FIG. 3, in accordance with aspects of the present disclosure, circuitry for the delivery system 1 is provided which is configured to carry out the following steps. In a first step S1, the circuitry is configured to monitor usage of a first device in the delivery system 1. In a second step S2, the circuitry is configured to determine that there is data available for transfer between the first device and a second device of the delivery system 1, based on monitoring the usage of the first device. In a third step S3, the circuitry is configured to initiate a procedure for transfer of data between the first and second devices over a data communication interface, based on determining there is data available for transfer between the first and second devices. There steps are described further herein.

In some embodiments, circuitry of the delivery system 1 is configured to monitor one or more aspects of usage of a first device of the delivery system 1, and/or one or more aspects of the behaviour of a user of the first device. Such data may be considered to comprise usage data relating to use of the first device. It may be advantageous for such usage data, collected by the circuitry, to be shared with other devices in the delivery system 1, so that it can be stored (for example, backed up), and/or analysed, and/or used to control operational aspects of one or more further devices of the delivery system 1.

In some embodiments, circuitry is configured to monitor direct interactions of a user with a first device (for example, an aerosol delivery device 10) and record this information as usage data. In general, the circuitry will be comprised in the first device, however, this is not essential, and a different device of the delivery system 1 may monitor these interactions as set out further herein. These interactions may relate to the vaping/consumption and/or manipulation/handling and/or setting of parameters on the first device and/or connection of the device with further devices of the delivery system 1. Where the first device is an aerosol delivery device 10, usage data relating to direct interactions may be stored by circuitry comprised in controller 22, being based on inputs received from sensors and buttons, such as airflow sensor 30, buttons 14 and 16, and other sensors as described further herein.

Vaping/consumption based interactions stored as usage data may relate to the number, frequency, and/or distribution/pattern of puffs/acts of consumption within one or more chosen periods. Such periods may include daily, hourly, as a function of location, as a function of pharmokinesis (for example the active ingredient half-life within the body for one or more delivered active ingredients), or any other period that may be relevant to the user's state, and/or chosen to increase the apparent correlation between number, frequency and/or distribution/pattern of puff/consumption and a user's state.

Vaping based interactions may also relate to individual vaping actions or statistical descriptions of a cohort thereof (for example but not limited to a cohort within one of the above-described chosen periods), such as duration, volume, average airflow, airflow profile, active ingredient ratio, heater temperature, and the like.

Where the first device is an aerosol delivery device 10, the device may comprise one or more airflow sensors 30 and/or buttons 14/16 as described previously herein to determine when the user vapes and/or how the user vapes, for example as characterised above. The data may then be used to determine features such as the number, frequency, and/or distribution/pattern of puffs/acts of consumption within one or more chosen periods, and/or the duration, volume, average airflow, airflow profile, average ingredient ratio, heater temperature values for one or more vaping/consumption events, using a processor of the delivery device.

Manipulation/handling based interactions may relate to how the user interacts with the first device. For example, sensors may be used to characterise whether a first device (e.g. an aerosol delivery device 10 or smartphone 100) is kept in a bag until immediately prior to use, or whether the user plays or fidgets with it in between uses. The first device may comprise one or more touch by sensors or accelerometers to determine such interactions. Similarly, the first device may comprise buttons and other settings for which user interactions may be logged.

Connection interactions may relate to the establishment of data connections between the first device and further devices of the delivery system 1. For example circuitry may monitor how frequently a wired or wireless connection is established between a first device comprising an aerosol delivery device 10 or smartphone 100 and one or more further devices of the delivery system 1, the identity of devices to which it established connections, and a record of the amount of data and/or the identity of any data transferred (e.g. whether the data comprised usage data and/or control parameters and/or software updates). It will be appreciated the circuitry monitoring connection interactions may be comprised on either of the first or further devices.

Though the collection of usage data has been described in particular relation to an aerosol delivery device 10 or smartphone 100, it will be appreciated that the first device whose usage is monitored by the circuitry may comprise any further device of the delivery system 1, such as a device case or dock 200, vending machine 300, wearable 400 or server 1000. Circuitry of the delivery system 1 may be configured to monitor direct interactions by a user with any of these classes of device, and record this information as usage data, and this may be achieved in a similar manner to that set out herein for an aerosol delivery device 10 (e.g. via the use of sensors to monitor usage and analyse and/or store data on a memory storage element comprising a flash or cloud memory element). For instance, circuitry on a smartphone 100 may monitor usage of an application (‘app’) which is used by the user to record information about the use of an aerosol delivery device 10. For example, the app may monitor purchases of consumables for the aerosol delivery device 10 and record data relating to the frequency of purchases and the type of consumables purchased by the user (in terms of flavours/concentrations of active ingredients). The app may also receive user inputs relating to use of one or more aerosol delivery devices 10, such as how often consumables are exhausted, and what consumables are used with the aerosol delivery device(s) 10. Where the delivery system 1 comprises a case or dock 200, circuitry of the dock may monitor information relating to how often aerosol generating material and/or electrical energy is supplied to the aerosol delivery device 10, and connection information about how regularly and for how long the aerosol delivery device 10 1 is engaged with the dock 200. Where the delivery system 1 comprises a vending machine 300 (for example, providing consumables for use with an aerosol delivery device 10), circuitry of the vending machine 300 may monitor the frequency and type of purchases made by a user of the delivery system 10. Monitored data may be stored on the device, and/or uploaded to a form of cloud storage via the internet 500.

The monitoring of usage of a given first device of the delivery system 1 may also comprise the collection of situational or contextual information about the first device, and/or about the actions and/or identity of a user of the first device. For example, control circuitry of the first device may monitor locational information, relating to a geographical location of the first device. For example, the first device may comprise a GPS receiver module which enables it to track its geographical location. The first device may also comprise circuitry which tracks date and time information. Other contextual information monitored by the first device may relate to interactions with other devices, for example, relating to how frequently the first device is paired with other devices. Other contextual information relating to the first device and/or a user of the first device may be derived from one or more calendars and/or databases providing contextual information about a user of the first device, such as country, religion, employment, gender and the like. Where such usage information is obtained by circuitry of the delivery system 1, this may be achieved via a connection to a relevant server 1000 via the internet 500. For example, a first device comprising a smartphone 100 may download information about a user from an online calendar, and one or more social media accounts.

It will be appreciated that usage data monitored by circuitry on a first device may be available at circuitry on a second device, and the usage data may therefore be considered to be monitored by circuitry comprised in the second device. For example, an aerosol delivery device 10 may collect any of the forms of usage data described herein, and may continuously or periodically transmit these data to a second device of the delivery system 1 (such as a smartphone 100, dock/case 200, vending machine 300, wearable 400 or server 1000) via a wired or wireless connection as described further herein. This may be advantageous, particularly if the first device has a relatively small memory capacity. For example, an aerosol delivery device 10 may periodically transmit usage data to a second device such as a smartphone 100 over a communications interface (such as a Bluetooth, ZigBee or RFID connection), whereupon the usage data is stored by a memory element of the first device. Once the aerosol delivery device 10 has transmitted the usage data, it may then clear it from memory (for example, from a memory module comprising flash memory associated with controller 22) so the storage space can be made available on the aerosol delivery device 10 for storing future usage data. Accordingly it will be appreciated that circuitry of a first device in delivery system 1 may be considered to monitor usage of a second device of delivery system 1 if the circuitry of the first device receives usage data from the second device over a wired or wireless data communication interface. Accordingly, circuitry comprised in a smartphone 100, dock 200, vending machine 300, wearable 400 or server 1000 may be considered to monitor usage of an aerosol delivery device 10 by virtue of periodically or continuously obtaining data collected by aerosol delivery device 10.

It will also be appreciated that circuitry of a first device may monitor usage of a second device from which it does not receive any data. For example, circuitry of a smartphone 100 may acquire usage data comprising geographical information relating to the location of the smartphone 100 over time, and/or other contextual information relating to the identity and behaviour of a user, derived, for example, from online calendars and social media accounts of the user. This monitoring may be considered to comprise monitoring of usage of another device of the delivery system 1 (for example, an aerosol delivery device 10, dock/case 200 or wearable 400). This may be considered to be ‘implicit’ monitoring of usage of the first device. For example, if a user of the delivery system 1 uses an aerosol delivery device 10, a smartphone 100 and a wearable 400, usage data collected by the smartphone 100 or the wearable 400 may be considered to relate to usage of the aerosol delivery device 10, and therefore comprise usage data associated with the aerosol delivery device 10. For example, information about the geographical location of the smartphone 100 may be considered to apply equally to the aerosol delivery device 10, since the same user will generally carry both the devices simultaneously, and the location of the smartphone 100 can thereby generally be considered to correspond to that of the aerosol delivery device 10. Similarly, contextual information about the user of the smartphone 100 obtained by circuitry of the smartphone 100 from, for example, social media accounts, calendars or email accounts, can be considered to be data relating to usage of an aerosol delivery device 10 based on the assumption that the same user interacts with both the smartphone 100 and the aerosol delivery device 10.

Other forms of data may also be available at a given device of the delivery system 1, which may in some instances be advantageously transferred over a wired or wireless connection to a further device of the delivery system 1. For example, in some embodiments, control parameters or software updates for modifying the behaviour of a first device may be transmitted to the first device by a second device. For example, in some embodiments circuitry of a smartphone 100, dock 200, vending machine 300 or wearable 400 may store parameters relating to control of an aerosol delivery device 10. Such parameters may comprise any control parameter known in the art, and by way of non-limiting examples, may relate to heater control (for example, parameters specifying one or more power levels or durations of heating cycles), determination of depletion of a consumable (e.g. a threshold used to specify when a consumable is to be considered exhausted), authentication of the device (e.g. a parameter or code relating to device unlocking or age verification), graphical displays (e.g. colours or graphics to be displayed when certain functions are active on the device), or sounds (e.g. audible alerts to be played to indicate certain functions are active on the device), or haptic signals such as vibrations. It will be appreciated that an aerosol delivery device 10 may also store control parameters for modifying aspects of behaviour of other devices of the delivery system 1, such as parameters for modifying the operation of a smartphone 100, dock 200, vending machine 300, wearable 400 or server. Control parameters may be derived by circuitry of a first device of the delivery system 1, for transfer to a further device of the delivery system 1, on the basis of data acquired by monitoring of usage of any of the devices of the delivery system 1.

It will therefore be appreciated that data available for transfer at a first device may comprise usage data, or any other data, such as software or firmware updates which can be used to reprogram and/or update the functionality of one of the first and second devices. For example, circuitry of a smartphone 100, dock 200, vending machine 300 or wearable 400 may store firmware for modifying the behaviour of a controller 22 of an aerosol delivery device 10. This firmware may be advantageously transmitted to the aerosol delivery device 10 over a wired or wireless interface as described further herein. The specific identity and purpose of the data available for transfer between first and second devices of the delivery system 1 is not significant.

According to an aspect of the present disclosure, the circuitry is configured to determine that there is data available for transfer between the first and second devices of a delivery system 1 based on monitoring the usage of the first device, and to initiate a procedure for transfer of data between the first and second devices based on determining there is data available for transfer between the first and second devices. As set out further herein, it will be appreciated that the specific device of the delivery system 1 in which the circuitry is comprised is not of primary importance. Accordingly, the circuitry may be comprised in the first device (i.e. the device whose usage is monitored by the circuitry), the second device (i.e. the device with which the first device may transfer data following initiation of a procedure to transfer data between the first and second devices), or a further device of the delivery system 1 (i.e. a third device which is configured to receive data from the first device and/or the second device, either directly, or over a relayed data communication interface as described further herein).

There are a number of different ways in which the circuitry may determine that there is data available for transfer between the first and second devices of a delivery system 1. In some embodiments, the determination by the circuitry that data is available for transfer can be considered to be explicit. This will generally, though not exclusively, be the case when the circuitry which determines data is available for transfer is comprised in the same device on which the data is available. For example, as one non-limiting example of an explicit determination, the circuitry may be comprised in controller 22 of an aerosol delivery device 10, and the determination that data is available for transfer between the aerosol delivery device 10 and a further device of the delivery system 1 is based on the circuitry establishing an amount and/or identity of certain data on a memory element of the aerosol delivery device 10 meets a predefined criterion (for example, establishing a quantity of usage data/control parameter data/software update data, or other data as described herein, stored on the aerosol delivery device 10). In some embodiments, the circuitry determines there is data available for transfer between the first and second devices of the aerosol delivery system 1 on the basis of determining that an amount of data (e.g. usage data or updates) stored on the first device has reached a predefined threshold. This may comprise determining that an amount of memory remaining free for storage of usage data on the first device has fallen below a predefined threshold, such as, for example 10% of the total capacity of a memory element such as a flash memory chip. However, such a threshold can be set to any suitable value. If it is desirable to more frequently initiate a procedure for transferring data between the first and second devices, a threshold level of data to be used by the circuitry to determine there is data available for transfer may be set lower. If it is desirable to less frequently initiate the procedure, the threshold level may be set higher. In some embodiments, the threshold may be multiplied by a random coefficient to introduce stochastic variation into the procedure used to determine there is data available for transfer.

In some embodiments, the determination by the circuitry that there is data available for transfer between the first and second devices comprises the circuitry determining that a control parameter or software/firmware update is available for one of the first and second devices. For example, the first device may comprise a server 1000 or smartphone 100, and based on monitoring the server 1000 or smartphone 100, the circuitry may determine that one or more control parameters or software/firmware updates have become available at the server 1000 or smartphone 100 which may be advantageously transferred to another device of the delivery system 1 (for example, an aerosol delivery device 10, smartphone 100, dock/case 200, vending machine 300 or wearable 400). The manner in which such updates become available at a first device may be broadly conventional.

In some embodiments, the circuitry determines there is data available for transfer between the first and second devices by receiving signalling from one of the first and second devices. For example, the circuitry may be comprised in a first device, which receives signalling such as a paging message or beacon signal from a second device, and determines from the paging message or beacon signal that data is available for transfer between the first device and a further device. In some embodiments, the first device comprises a smartphone 100, and the second device comprises an aerosol delivery device 10. The smartphone 100 is equipped with a wireless receiver module (e.g. a Bluetooth module as described further herein) which monitors for Bluetooth signalling in the vicinity of the smartphone 100. The aerosol delivery device 10 is configured to transmit beacon or paging signals which provide information about data availability. For example, the aerosol delivery device 10 may periodically transmit a message containing an indication (e.g. an indicator bit) the value of which is set in dependence on whether or not there is data available on the aerosol delivery device 10. An indication that there is data available for transfer, provided via signalling transmitted by the first device, may also comprise an indication that the first device is available to receive a transfer of data from the second device. This may comprise an indication that a software or firmware update is required, or that one or more control parameters is required. A second device, such as a smartphone 100 or networked transceiver (such as a base station connected to a server 1000), may monitor for beacon or paging signals from one or more aerosol delivery device 10s 10. Upon receiving signalling from an aerosol delivery device 10 indicating there is data available for transfer between the aerosol delivery device 10 and a further device, the second device may initiate a procedure for a transfer of data between these devices, using approaches described further herein. The signalling received from the aerosol delivery device 10 may explicitly indicate a further device which the aerosol delivery device 10 would like to transfer data, and the second device may accordingly provide an audible or visual or haptic prompt to a user via one of the devices of the aerosol delivery system 1 to consider establishing a connection between the aerosol delivery device 10 and the further device (for example, by establishing a Bluetooth link or wired connection between the aerosol delivery device 10 and the further device).

In some embodiments, the circuitry determines there is data available for transfer between the first and second devices of the aerosol delivery system 1 on the basis of data derived from monitoring connection interactions of a first device with a further device of the aerosol delivery system 1. As set out further herein, usage data monitored by circuitry may comprise information relating to the periodicity with which data connections are established between a first device and at least one second device of the aerosol delivery system 1, the identity of the device(s) with which the first device has previously established a connection, and the identity and quantity of data transferred during a given connection. For the sake of providing a concrete example, in some embodiments, a first device comprises an aerosol delivery device 10, and the second device may comprise a smartphone 100, a case/dock 200, a vending machine 300, a wearable 400 or a server 1000. As set out further herein, the aerosol delivery device 10 may directly or indirectly connect to any of these further devices of the delivery system 1 (for example, by using an intermediate device to relay information to the further device). In some embodiments, the circuitry is comprised in the aerosol delivery device 10, and is configured to monitor usage data comprising information about data connections established between the aerosol delivery device 10 and the one or more further devices of the delivery system 1 (e.g. a smartphone 100). In other embodiments, the circuitry may be comprised in the second device of the delivery system 1 (e.g. in a smartphone 100) and is configured to monitor usage data comprising information about data connections established between said second device and the aerosol delivery device 10. In these embodiments, a determination that there is data available for transfer between the first and second devices of the aerosol delivery system 1 may be made by the circuitry on the basis of the elapsed time since a data connection was last established between the first device and a given second device of the aerosol delivery system 1. Approaches for establishing a suitable threshold are described further herein, but may for example be established from a look-up table based on a usage profile assigned to the user of the first and/or second devices on the basis of usage data collected from monitoring usage of the first and/or second devices.

An explicit determination that data is available for transfer between first and second devices may be made by circuitry comprised in the first device on the basis of information received from the second device. For example, the first device may receive a message from the second device (e.g. via a beacon or paging message transferred over a wireless interface) that there is data available for transfer on the second device, and accordingly the circuitry of the first device may make an explicit determination that data is available for transfer between the second device and a further device (which may be the first device, or a third device), and initiate a procedure for transfer of data between the first and second devices on the basis of this determination.

In some embodiments, the circuitry may determine there is data available for transfer between first and second devices of the delivery system 1 based on what may be considered an implicit determination procedure. This will generally, though not exclusively, be the case when the circuitry which determines data is available for transfer is not comprised in the same device on which the data is available. An implicit determination may generally be considered to be a determination which is made based on analysing user behaviour and/or identity and/or interaction with a given device of the delivery system 1, and may be considered to comprise an estimation that one or more devices are likely to be in a state where data may be available for transfer, without the circuitry explicitly identifying the identity or amount of such data. For example, in some embodiments, usage data comprising direct interaction data and/or contextual data about a user and how the user uses one or more devices (as described further herein) may be used to establish a user profile for a user of the one or more devices. For example, the circuitry may directly or indirectly receive data relating to, for example, how often a user of an aerosol delivery device 10 puffs on the device, the duration of each puff, and/or total puff duration. For the sake of a non-limiting example, the circuitry may be comprised in a smartphone 100, and may receive this usage data periodically from an aerosol delivery device 10 over a wired or wireless connection. The circuitry may use the usage data to establish a usage profile, which may broadly be considered to relate to how intensely the user uses the device. In one embodiment, a measure of total puff duration with respect to time over a certain integrating period, derived from usage data, may be used to classify the user into one of a number of intensity profiles. The intensity profile of the user may be used to determine an appropriate frequency with which a procedure to initiate transfer of data between the smartphone and aerosol delivery device 10 should be initiated. For example, more intensive use of the aerosol delivery device 10 may be considered generally to lead to a higher rate of usage data acquisition by the controller of the aerosol delivery device 10. Accordingly, for a user with a more intense usage profile, the circuitry may determine that it would be appropriate to initiate a procedure for transfer of data between the first and second devices more regularly, to avoid scenarios in which the available memory for storage of usage data on the aerosol delivery device 10 is depleted. This may be achieved by using a look-up table to determine an appropriate elapsed time since the last data connection after which to initiate a procedure for transfer of data. It will be appreciated that assignment of a usage profile to a given user may also be based on contextual and situational information which does not relate to direct interaction of the user with one or more devices of the delivery system 1. For example, the circuitry may assign a usage profile to a user on the basis of usage data from monitoring of direct interactions with one or more devices, and other information derived from, for example, social media accounts, email accounts, and calendars associated with a user of the one or more devices, and/or on the basis of information about the user provided by the user via, for example, a questionnaire on a smartphone app or web interface. Such information may comprise information about the gender, age, and preferences of the user. In some embodiments, such contextual information may be used to assign a user profile without the use of information about direct interactions with one or more devices of the delivery system 1.

Where the circuitry monitors usage of a first device and determines a user profile based on said usage data, this usage data can comprise any combination of data arising from monitoring of direct interactions with one of more devices of the delivery system 1, as set out further herein (for example, the periodicity and duration of puffs on an aerosol delivery device 10, purchases of consumables made using a vending machine 300, periodicity of charging and refilling of an aerosol delivery device 10 by a refill dock 200, a history of data connections made between any two devices of the delivery system 1 and the identity and amount of data transferred, and information input by a user to an app on a smartphone 100). It will be appreciated that the monitoring of usage of the first device by the circuitry does not necessitate that the circuitry is comprised in the first device, nor that the circuitry receives any data from the first device. On the basis of usage data relating to usage of a first device, the circuitry may in some embodiments use a model to assign a usage profile to the user of one or more devices of the delivery system 1. A usage profile may be established from usage data using any approach used in the art for assigning a class or value to a set of input data (e.g. usage data), for example, using machine learning approaches or a look-up table. Such a model or classifier may be parameterised using historic usage data for one or more users of the delivery system 1 (or other similar delivery system 1s), and explicit knowledge about the users to whom the usage data relates. On the basis of the usage data, such a model or classifier, operating on the circuitry, may classify the user as belonging to a certain predefined usage profile. Alternatively, the user may be characterised a variable which represents their usage of one or more of the devices in the delivery system 1. In some embodiments, the determination by the circuitry that there is data available for transfer between first and second devices of the aerosol delivery system 1 comprises the circuitry establishing that category or variable assigned to the user by the model on the basis of the usage data has changed. For example, the model may determine based on geographical information and calendar information relating to a user of an aerosol delivery device 10 that at a first point in time, the user is likely to be at work. For example, the user may be determined to be in a geographical location which correlates with a known location of the user's place for work. On the basis of such a determination, the user may therefore be assigned an ‘at work’ category by the circuitry. However, at a later point in time, the model may determine based on, for example, geographical information and calendar information, that the user of the aerosol delivery device 10 is likely to be at home or engaged in a recreational activity. On the basis of such a determination, the user may therefore be assigned a ‘leisure’ category by the circuitry. On the basis of determining that the category has changed from ‘at work’ to ‘leisure’, the circuitry may initiate a procedure for transfer of data between the aerosol delivery device 10 and a second device. For example, the circuitry may prompt a user via a smartphone app to connect the aerosol delivery device 10 to a smartphone 100 so that control parameters may be transmitted from the smartphone 100 to the aerosol delivery device 10. These control parameters may be determined by the circuitry as being more appropriate for the user's current usage profile.

In some embodiments, the circuitry may make a determination that there is data available for transfer based on contextual information, such as geographical information or calendar information. For example, the circuitry may determine from geographical information or from information derived from an electronic calendar or other online account (for example a social media account) that a user is likely to be in a certain location at a certain time. This information may be used by the circuitry to infer that a first device associated with the user (for example an aerosol delivery device 10) is likely to be in the vicinity of a second device of the delivery system 1. For instance, GPS information indicating a location of a first device comprising an aerosol delivery device 10 or comprising a smartphone 100 belonging to the user, or calendar information derived by an app of a first device comprising a smartphone 100, may be used to predict that the user of the first device is at home, and therefore in the vicinity of a second device comprising a docking station or case 200, or that the user is in a shopping mall and therefore in the vicinity of a second device comprising a vending machine 300, or that the user is in the vicinity of a second user who owns a second device comprising an aerosol delivery device 10 and/or a smartphone 101. Based on this determination the circuitry may initiate a procedure for transfer of data between the first and second devices. This data may comprise usage data, or control parameters/software updates, or information relating to marketing or gaming. For instance, the circuitry may determine based on estimating location of a first device comprising a smartphone 100 or aerosol delivery device 10 that a user of the first device is in a shopping mall (or point of sale relating to the aerosol delivery device 10 and/or consumables or accessories for the aerosol delivery device 10), and may on this basis determine to initiate a procedure to establish a connection between the first device and a networked transceiver device in the shopping mall (for example a base station connected to a server 1000 via the internet 500) so that marketing information such as an offer for purchase of consumables, or a game, can be transmitted to the first device comprising an aerosol delivery device 10 or smartphone 100, or so that control parameters can be transmitted to the first device to change an aspect of its operation, or so that usage data collected by the first device can be retrieved from the first device. In other embodiments, the circuitry may initiate a procedure to establish a connection between the first device and the networked transceiver device in order to transfer data from the first device (e.g. an aerosol delivery device 10 or smartphone 100) to the server 1000 via the networked transceiver device. In some embodiments, the networked transceiver device may comprise a smartphone 100 or vending machine 300 which is connected to server 1000 via the internet 500.

Once the circuitry has determined that data is available for transfer between first and second devices of the delivery system 1 on the basis of monitoring usage of the first device, the circuitry may initiate a procedure for transfer of data between the first and second devices. It will be appreciated that such a procedure may be initiated in a variety of different ways. For example, the circuitry may provide an audible or visual or haptic prompt to a user. Such a prompt may comprise an implicit or explicit indication suggesting that the user initiates a data connection between the first and second devices (for example a wired or wireless connection as described further herein). Such an indication may in principle be provided on any device of the delivery system 1, which need not comprise the device in which the circuitry used to determine data is available for transfer is comprised.

In some embodiments, the determination that data is available for transfer is made by circuitry comprised in an aerosol delivery device 10, according to approaches described further herein. An indication to a user (for example, a predefined audible or visual or haptic signal as described further herein) may be provided on the aerosol delivery device 10 to indicate that the user should consider establishing a data connection between the aerosol delivery device 10 and a further device of the delivery system 1. Similarly, where the determination that data is available for transfer is made by circuitry comprised in a smartphone 100, case/dock 200, vending machine 300 or wearable 400, the indication may be provided on the same device comprising the circuitry. However, though an indication (where provided) may be provided on the device comprising the circuitry, this is not essential. For example, in some embodiments, data as described further herein is available on a first device (e.g. an aerosol delivery device 10), for transfer to a further device of the delivery system 1. Circuitry comprised in a second device (e.g. a server 1000) may determine via approaches set out further herein (for example, an implicit determination approach) that this data is available, and further determine that it would be advantageous for this data to be transferred to an app on smartphone 100 connected to the server 1000 via the internet 500. Accordingly, the server 1000 may transmit signalling to any of the aerosol delivery device 10, the smartphone 100, dock/case 200, vending machine 300, and wearable 400 to prompt the device to provide a prompt to the user to establish a data connection between the first device (e.g. the aerosol delivery device 10) 10 and a second device (e.g. a smartphone 100) so that the can be transferred between these device. For instance, the server 1000 may transmit signalling via the internet to one of the devices in the delivery system 1 to display a message on a display (e.g. on a screen or LED indicator of smartphone 100, dock/case 200, vending machine 300 or wearable 400), such as a text prompt reading “consider pairing your e-cigarette with your smartphone” and/or provide a visual indicator of a predefined colour and/or pattern, and/or an audible signal such as a predefined voice alert or musical tone, and/or a haptic signal such as a vibration which the user will recognise as indicating that a data connection should be established.

In some embodiments, the circuitry may initiate a procedure for transfer of data between the first and second devices by automatically or partially-automatically establishing a data connection between the first and second devices. In some embodiments, the data connection comprises a wireless data connection as described further herein. In such embodiments, the automatic or partially-automatic establishment of a data connection between the first and second devices may be established in one of the following ways. In some embodiments, the circuitry which initiates the procedure for transfer of data between the first and second devices over a data communication interface is comprised in a first device (for example an aerosol delivery device 10). The circuitry may, for example, be configured to establish a Bluetooth link with a second device (for example a smartphone 100) to transfer data with the second device. The circuitry, having determined that data is available for transfer between the first and second devices according to approaches set out further herein, may seek to establish a paired state with the second device and transfer the available data. The pairing process following the determination of data availability may be carried out without requiring user interaction. For example, the first device (e.g. an aerosol delivery device 10) may previously have been paired to the second device (e.g. a smartphone 100 or dock/case 200) by a user, and the devices are considered to be known to one another (this may involve the user having entering authentication information, for instance a pin or code, on one or both devices to confirm the devices should be allowed to enter a paired state). Accordingly, the circuitry may be able to initiate a procedure to pair the first and second devices (according to procedures known in the art for device discovery and connection), and initiate a transfer of the available data between the first and second devices over the data communication interface established by the pairing procedure, without requiring the user to initiate or authenticate the pairing procedure manually.

In some embodiments, the establishment of a data connection and/or data transfer between the first and second devices may be indicated to the user, for example, using a visual indication such as a progress bar, or using an audible or haptic signal. In some embodiments, the user is provided with a visual or audible or haptic prompt on a first one of the first and second devices, indicating a request for authorisation to establish a wireless communication and/or initiate a transfer of data between the first one of the first and second devices and the second one of the first and second devices. Where the prompt is provided on, for example, a first device comprising a smartphone 100 or an aerosol delivery device 10, the user may be able to confirm or decline the proposed pairing and/or data transfer actions, via an input such as a button press, a gesture, or a pattern of puffs on a device (where the device is an aerosol delivery device 10). The circuitry may then either continue to automatically continue with establishing a data connection and/or transferring data between the first and second device based on feedback from the user, or may decline to establish a data connection. It will be appreciated that a similar scheme may be used in embodiments where the first and second devices are configured to connect over a wired connection. For example, the first device may comprise an aerosol delivery device 10 which can be connected to a second device comprising a dock 200 via a USB-C or other wired interface. If circuitry of the first or second device (or a further device) determines to initiate a data connection between the first and second device, the circuitry may be configured to first detect whether the first and second devices are physically connected (e.g. via the USB-C interface). If so, the circuitry may then begin the procedure to establish a data connection and transfer data between the first and second devices, either without user interaction, or using prompts to ask the user to confirm the data connection should be established, and/or data should be transferred, in accordance with the procedure described in relation to the wireless connection scenario. If the circuitry determines the first and second devices are not physically connected, the circuitry may either optionally provide an indication to the user via one of the first and second devices to physically connect the devices via the wired interface, or wait until the next time a physical connection is established, then when the physical connection is established, either automatically establish a data connection and/or transfer available data between the devices, or prompt the user to confirm or decline the proposed establishment of a data connection and/or data transfer using approaches as set out for the wireless connections scenario.

In the above disclosure, it will be appreciated that the step of circuitry establishing there is data available for transfer at a first device may comprise establishing an absence of a certain kind of data on a given device. For instance, determining there is data available for transfer at a first device comprising an aerosol delivery device 10 may comprise determining, either explicitly or implicitly, that a certain control parameter is not present (or likely to be present) on a controller of a first device.

In the above disclosure, it will be appreciated that circuitry may refer to hardware and/or may be used to refer to a software routine running on a multipurpose processing device. The required adaptation to existing parts of a conventional equivalent device of the delivery system 1 may be implemented in the form of a computer program product comprising processor implementable (computer executable) instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future. The delivery system 1 described herein can be implemented as a combustible aerosol provision system, a non-combustible aerosol provision system or an aerosol-free delivery system.

1. Circuitry for an aerosol delivery system, the circuitry being configured to:
monitor usage of a first device in the aerosol delivery system;
determine that there is data available for transfer between the first device and a second device of the aerosol delivery system, based on monitoring the usage of the first device; and
initiate a procedure for transfer of data between the first and second devices over a data communication interface, based on determining there is data available for transfer between the first and second devices.

2. The circuitry of claim 1, wherein determining there is data available to be transferred comprises determining an amount of data stored on the first device has reached a predetermined threshold.

3. The circuitry of claim 1, wherein the data available to be transferred comprises usage data collected by the first device.

4. The circuitry of claim 1, wherein the data available to be transferred comprises data to be transferred from the second device to the first device in order to modify the operation of the first device.

5. The circuitry of claim 4, wherein determining that there is data available to be transferred from the second device to the first device comprises determining a certain time has elapsed since data for modifying the operation of the first device was last received by the first device.

6. The circuitry of claim 4, wherein the data comprises a software update or a control parameter for modifying the operation of the first device or second device.

7. The circuitry of claim 1, wherein monitoring the usage of the first device comprises monitoring how often a data connection is established between the first device and the second device.

8. The circuitry of claim 7, wherein determining there is data available to be transferred between the first and second devices comprises determining that a certain time has elapsed since a data connection was last established between the first device and the second device.

9. The circuitry of claim 8, wherein the elapsed time after which it is determined data is available to be transferred is determined based on information about the user of the first device.

10. The circuitry of claim 9, wherein the information about the user comprises at least one of the following:
i) information derived from the activity of the user on an online application
ii) information about the location and/or movement of the user
iii) information provided by the user via a form or questionnaire
iv) information derived from sensing one or more physical characteristics of the user.

11. The circuitry of claim 10, wherein determining there is data available to be transferred between the first and second devices comprises determining that a user profile associated with the user has changed, wherein the user profile is established based on the information about a user of the first device.

12. The circuitry of claim 1, wherein monitoring the usage of the first device comprises monitoring the geographical location of the first device and/or the second device.

13. The circuitry of claim 12, wherein a procedure for the establishment of a data connection between the first and second devices is initiated based on determining the first device entered a predefined geographical location.

14. The circuitry of claim 12, wherein a procedure for the establishment of a data connection between the first and second devices is initiated based on determining the second device entered a predefined geographical location.

15.-21. (canceled)

22. The circuitry of claim 1, wherein initiating the procedure for transfer of data between the first and second devices comprises providing an indication via the first device that a user should establish a data connection for the transfer of data between the first and second devices.

23. The circuitry of claim 1, wherein initiating the procedure for transfer of data between the first and second devices comprises providing an indication via the second device that a user should establish a data connection for the transfer of data between the first and second devices.

24. The circuitry of claim 1, wherein initiating the procedure for transfer of data between the first and second devices comprises providing an indication via a further device of the aerosol delivery system that a user should establish a data connection for the transfer of data between the first and second devices.

25. The circuitry of claim 22, wherein the indication that a user should establish a data connection for the transfer of data between the first and second devices comprises an audible or a visual signal.

26.-28. (canceled)

29. A method of operating circuitry for an aerosol delivery system, the method comprising the steps of:
causing the circuitry to monitor usage of a first device in the aerosol delivery system;
determining that there is data available for transfer between the first device and a second device of the aerosol delivery system, based on monitoring the usage of the first device; and
initiating a procedure for transfer of data between the first and second devices over a data communication interface, based on determining there is data available for transfer between the first and second devices.

30. (canceled)

31. An aerosol delivery device for use in an aerosol delivery system comprising a second device, the aerosol delivery device comprising circuitry configured to:
monitor usage of a first one of the aerosol delivery device and the second device;
wherein the circuitry is configured to determine that there is data available for transfer between the first and second devices, based on monitoring the usage of the first one of the first device and second devices; and
initiate a procedure for transfer of data between the first and second devices over a data communication interface, based on determining there is data available for transfer between the first and second devices.

32. (canceled)
